(19) United States
(12) Patent Application Publication
(10) Pub. No.: US 2016/0066354 A1
(43) Pub. Date: Mar. 3, 2016

(54) COMMUNICATION SYSTEM

(71) Applicant: Kabushiki Kaisha Toshiba, Minato-ku (JP)

(72) Inventors: Yoshihiro OBA, Kawasaki (JP); Yoshikazu HANATANI, Komae (JP)

(73) Assignee: Kabushiki Kaisha Toshiba, Minato-ku (JP)

(21) Appl. No.: 14/799,129

(22) Filed: Jul. 14, 2015

(30) Foreign Application Priority Data
Aug. 28, 2014 (JP) 2014-174443

(51) Int. Cl. H04W 76/02; H04W 4/08; H04W 12/06

(52) U.S. Cl. CPC H04W 76/021; H04W 12/06; H04W 4/08

(57) ABSTRACT

According to an embodiment, a communication system is connected to a plurality of communication devices. The system includes a controller configured to control, by using a group identifier representing semantics of a group including at least one of the communication devices, the at least one of the communication devices that has been authenticated when the group is operated. An index is assigned to the at least one of the communication devices.

### CROSS-REFERENCE TO RELATED APPLICATION

This application is based upon and claims the benefit of priority from Japanese Patent Application No. 2014-174443, filed on Aug. 28, 2014; the entire contents of which are incorporated herein by reference.

### FIELD

An embodiment described herein relates generally to a communication system.

### BACKGROUND

In related art, methods for associating group identifiers assigned to packets with semantics in communication systems having home area network (HAN) devices or the like include static association methods such as request for comment (RFC) 2375 and dynamic association methods such as RFC 4566.

In the RFC 2375, signaling for associating group identifiers with semantics is not required but combinations of group identifiers and semantics are fixed and limited. In the RFC4566, combinations of group identifiers and semantics are flexible, but signaling for associating group identifiers with semantics is required and reference to association is required for each packet. Thus, the static association method and the dynamic association method of the methods for associating group identifier with semantics both have advantages and disadvantages.

### BRIEF DESCRIPTION OF THE DRAWINGS

FIG. 1 is a block diagram illustrating a configuration of a communication system according to an embodiment;

FIG. 2 is a diagram illustrating connections between controllers and devices according to the embodiment;

FIG. 3 is a table illustrating associations between node types according to the embodiment;

FIG. 4 is a block diagram illustrating a hardware configuration of devices according to the embodiment;

FIG. 5 is a block diagram illustrating a functional configuration of a coordinator according to the embodiment;

FIG. 6 is a diagram illustrating a group management tree and Leaf IDs according to the embodiment;

FIG. 7 is a table illustrating a group assignment rule according to the embodiment;

FIG. 8 is an overall sequence illustrating communication procedures according to the embodiment;

FIG. 9 is an authentication sequence according to the embodiment;

FIG. 10 is a key sharing sequence according to the embodiment;

FIG. 11 is a table illustrating default values of group communication security policies according to the embodiment;

FIG. 12 is a table illustrating security-policy-independent TLVs contained in MIH_Net_Group_Manipulate request messages according to the embodiment;

FIG. 13 is a table illustrating security-policy-independent TLVs contained in MIH_Net_Group_Manipulate response messages according to the embodiment;

FIG. 14 is a table illustrating security-policy-independent TLVs contained in MIH_MN_Group_Manipulate request messages according to the embodiment;

FIG. 15 is a table illustrating security-policy-independent TLVs contained in MIH_MN_Group_Manipulate response messages according to the embodiment;

FIG. 16 is a table illustrating security-policy-independent TLVs contained in MIH_Push_Certificate request messages according to the embodiment;

FIG. 17 is a table illustrating security-policy-independent TLVs contained in MIH_Push_Certificate response messages according to the embodiment;

FIG. 18 is a table illustrating security-policy-independent TLVs contained in MIH_Configuration_Update indication messages according to the embodiment;

FIG. 19 is a table illustrating security-policy-independent TLVs contained in MIH_Revoke_Certificate request messages according to the embodiment;

FIG. 20 is a table illustrating security-policy-independent TLVs contained in MIH_Revoke_Certificate response messages according to the embodiment;

FIG. 21 is a detailed sequence of a key sharing phase 1A according to the embodiment;

FIG. 22 is a detailed sequence of a key sharing phase 1B according to the embodiment;

FIG. 23 is a detailed sequence of a key sharing phase 2 according to the embodiment;

FIG. 24 is a detailed sequence of the key sharing phase 2 according to the embodiment;

FIG. 25 is a detailed sequence of encrypted communication according to the embodiment;

FIG. 26 is a detailed sequence of certificate revocation according to the embodiment; and

FIG. 27 is a detailed sequence of group key update according to the embodiment.

### DETAILED DESCRIPTION

According to an embodiment, a communication system is connected to a plurality of communication devices. The system includes a controller configured to control, by using a group identifier representing semantics of a group including at least one of the communication devices, the at least one of the communication devices that has been authenticated when the group is operated. An index is assigned to the at least one of the communication devices.

System Architecture

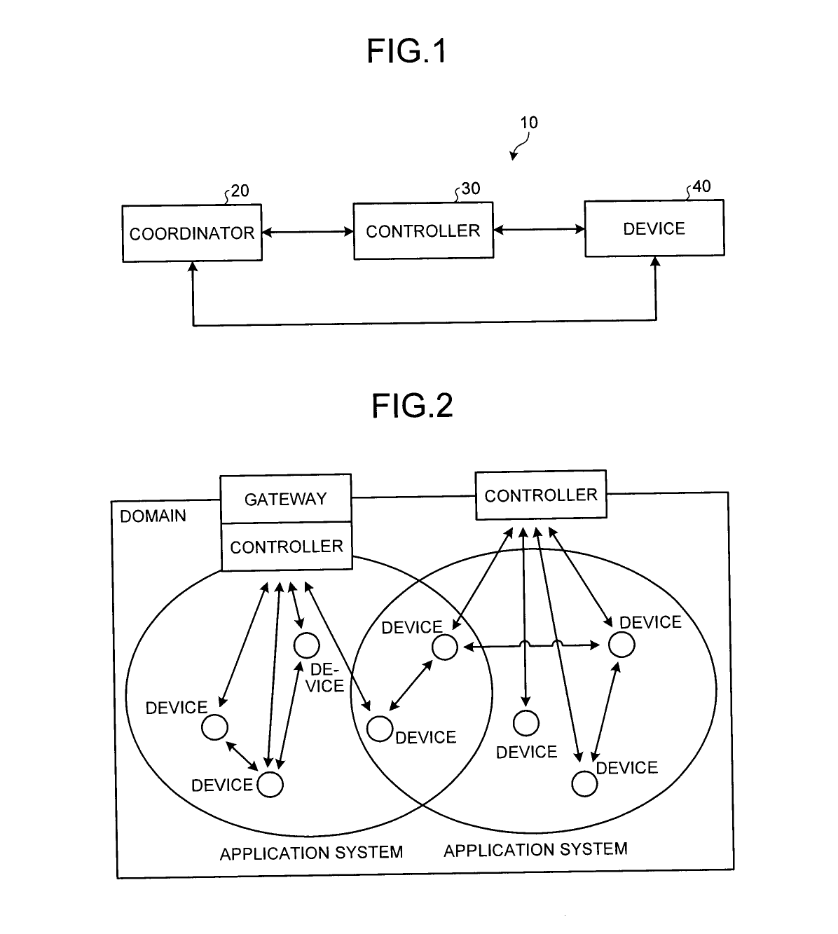

FIG. 1 is a block diagram illustrating an exemplary configuration of a communication system according to an embodiment. In the present embodiment, an example of security functions of an ECHONET Lite node will be described. An ECHONET Lite node supports a protocol for carrying authentication for network access (PANA) defined according to IEEE 802.21d and RFC 5191 as security functions.

As illustrated in FIG. 1, the communication system 10 includes a coordinator 20, a controller 30, and a device 40. Among them, one coordinator 20 is present in one ECHONET Lite domain (hereinafter may simply be referred to as a “domain”). A domain is one home area network (HAN), for example. At least one controller 30 is present in one domain. Thus, M (M≧1) controllers 30 are present. At least one device 40 is present in one domain. Thus, N (N≧1) devices 40 are present. FIG. 2 is a diagram illustrating connections between the controllers 30 and the devices 40 according to the embodiment. As illustrated in FIG. 2, at least one controller 30 and at least one device 40 are present in one domain. Furthermore, a device 40 belongs to a group (application system group) formed by a controller 30. Note that a device 40 may belong to a plurality of application system groups.

“Mutual authentication” and “key sharing” procedures are carried out between the coordinator 20 and the controllers 30. Similarly, “mutual authentication” and “key sharing” procedures are carried out between the coordinator 20 and the devices 40. Furthermore, “encrypted communication” is carried out between the controllers 30 and the devices 40. Encryption keys used for encrypted communication are distributed to the controllers 30 and the devices 40 by the coordinator 20 through the key sharing procedures. Note that encrypted communication may be carried out between the controllers 30 and between the devices 40. Detailed procedures of mutual authentication, key sharing, and encrypted communication will be described later.

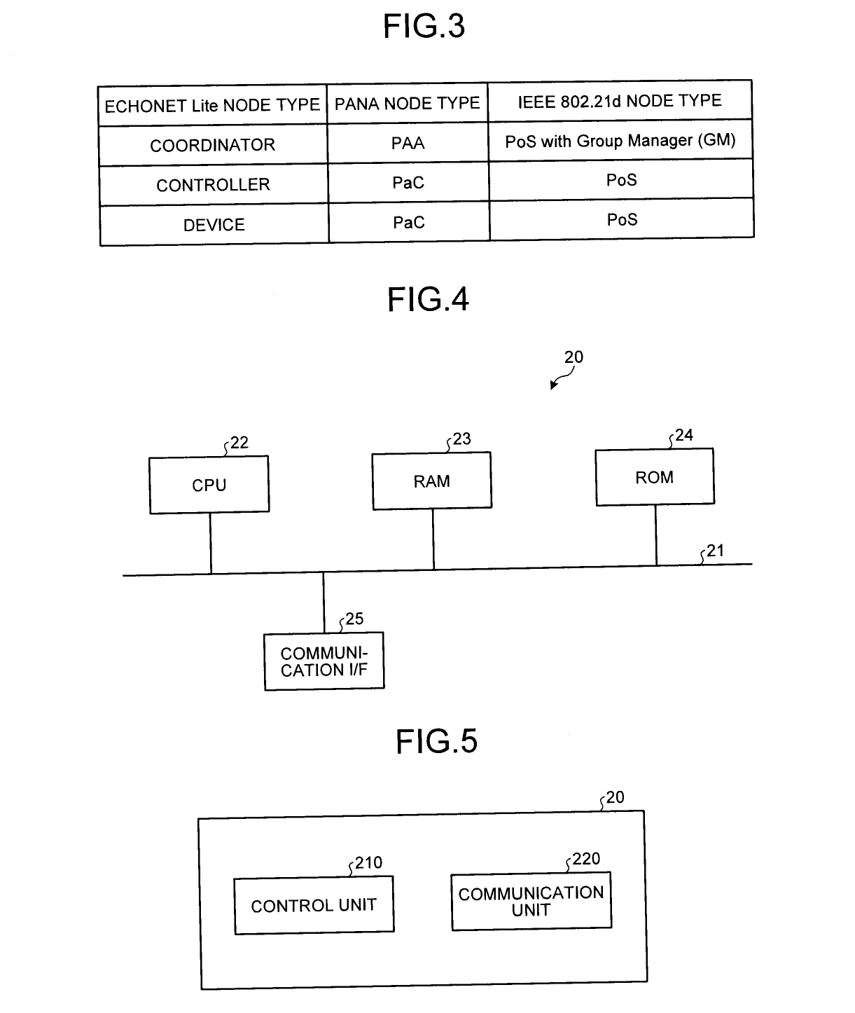

FIG. 3 is a table illustrating associations between node types according to the embodiment. FIG. 3 illustrates an example of association of an ECHONET Lite node type, a PANA node type, and an IEEE 802.21d node type. The coordinator 20 is a node that conducts group management and security management, and is defined as a new class in ECHONET Lite management and an operation-related device group. The controllers 30 and the devices 40 are existing classes in the ECHONET Lite management and the operation-related device group. The coordinator 20 has functions of a PANA authentication agent (PAA) according to PANA and a point of service (PoS) with a group manager (GM) according to IEEE 802.21d. The controllers 30 and the devices 40 have functions of a PANA client (PaC) according to PANA and a PoS according to IEEE 802.21d. Note that the coordinator 20 is not an ECHONET Lite node device. In this case, the communication system according to the present embodiment can also be applied to systems other than ECHONET Lite systems.

FIG. 4 is a block diagram illustrating an exemplary hardware configuration of the devices according to the embodiment. Herein, an example of the coordinator 20 will be described. As illustrated in FIG. 4, the coordinator 20 includes a central processing unit (CPU) 22, a random access memory (RAM) 23, a read only memory (ROM) 24, and a communication interface (I/F) 25. The hardware components are connected via a bus 21. The CPU 22 generally controls the operation of the coordinator 20. The CPU 22 controls the operation of the entire coordinator 20 by executing programs stored in the ROM 24 or the like using the RAM 23 as a work area (working area). The communication I/F 25 is an interface for communication with external devices (such as the controllers 30 and the devices 40).

FIG. 5 is a block diagram illustrating an exemplary functional configuration of the coordinator 20 according to the embodiment. As illustrated in FIG. 5, the coordinator 20 includes a control unit 210 and a communication unit 220. The control unit 210 generally controls the operation of the coordinator 20 and performs various processes. The processes will be described later. The communication unit 220 controls communication with the controllers 30 and the devices 40. Note that the controllers 30 and the devices 40 each have a control unit and a communication unit, and performs various processes, which will be described later.

Group Management

The security of ECHONET Lite can support four groups including a HAN group, an individual communication group, an application system group, and a controller group. Among these groups, the HAN group (the number of groups=1) can be used for encrypted communication between all of the ECHONET Lite nodes in a domain. In addition, in the HAN group, one group encryption key “K1” is shared by all of the ECHONET Lite nodes in the domain.

The individual communication group can be used for encrypted communication between two specific ECHONET Lite nodes. When the two specific ECHONET Lite nodes have identifiers x and y, a group encryption key K_xy or a group encryption key K_yx (in the present embodiment, K_xy=K_yx) is shared between the node x and the node y.

The application system group (the number of groups=M) can be used for encrypted communication between ECHONET Lite nodes (including the controller 30) connected to a specific controller 30. When the controller 30 has an identifier ctl, a group encryption key K_ctl is shared by the ECHONET Lite nodes connected to the controller ctl.

The controller group (the number of groups=1) can be used for encrypted communication between all the controllers 30 in a domain. In addition, in the controller group, one group encryption key K2 is shared by all the controllers 30 in the domain.

In group communication conducted in any of the four groups described above, encrypted communication according to IEEE 802.21d is conducted. In the following, ‘+’ is an operator representing connection of character strings, and Type refers to a character for identifying a type that is any of a Leaf ID, an EUI 64 address, and a short address, which are ‘L’ (Leaf ID), ‘E’ (EUI 64 address), and ‘S’ (IEEE 802.15.4 short address). IDx and IDy are identifiers (any of a Leaf ID, an EUI 64 address, and an IEEE 802.15.4 short address) of two ECHONET Lite nodes belonging to an individual communication group, and IDctl is an identifier (any of a Leaf ID, an EUI 64 address, and an IEEE 802.15.4 short address) of the controller 30 in an application system.

In this case, a Leaf ID, an EUI 64 address, or an IEEE 802.15.4 short address may be used as IEEE 802.21 SourceIdentifier assigned to a packet. IEEE 802.21 SourceIdentifier assigned to a packet is “L10”, “E00112233AABBCCDD”, or “S0011”, for example. A Leaf ID is an identifier of a leaf node in a group management tree of IEEE 802.21d, and can be used as an IEEE 802.21d node. Note that the identifier of a leaf node in a group management tree is an example of an index. An index represents an identifier such as a MAC address, for example.

The length of a Leaf ID is dependent on the size of a group management tree. In a group management tree including 256 leaf nodes, the length of a Leaf ID in BASE 16 encoding is 2 bytes. The length of an EUI 64 address in BASE 16 encoding is 16 bytes, and the length of an IEEE 802.15.4 short address in BASE 16 encoding is 4 bytes. Hereinafter, it is assumed that BASE 16 encoding is used for encoding a Leaf ID, an EUI 64 address, and an IEEE 802.15.4 short address.

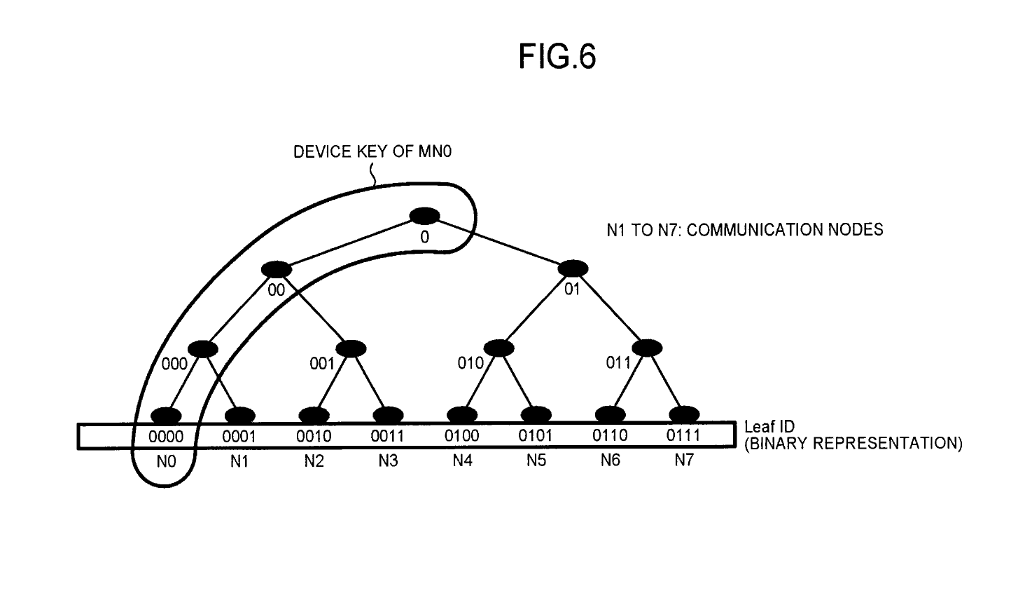

FIG. 6 is a diagram illustrating a group management tree and Leaf IDs according to the embodiment. In FIG. 6, Leaf IDs are expressed by binary representations. In the group management tree, leaf nodes and communication nodes correspond one-to-one to each other. Furthermore, each of the nodes in the group management tree is associated with a unique 128-bit encryption key. Note that a list of encryption keys for a certain communication node, which are associated with nodes present on a path from a root node to a leaf node, is referred to as a device key for the communication node. For a node NO, for example, the nodes present on the path from the root node to the leaf node are a node 0, a node 00, a node 000, and a node 0000. The device key for a communication node is shared between the communication node and the GM. When members of a group include communication nodes N0, N1, N2, and N3, for example, the node key used for key encryption is the node key of the node 00. When members of a group include communication nodes N1, N2, N3, N4, N6, and N7, the node keys used for key encryption are the node keys of the node 00, a node 0100, and a node 011.

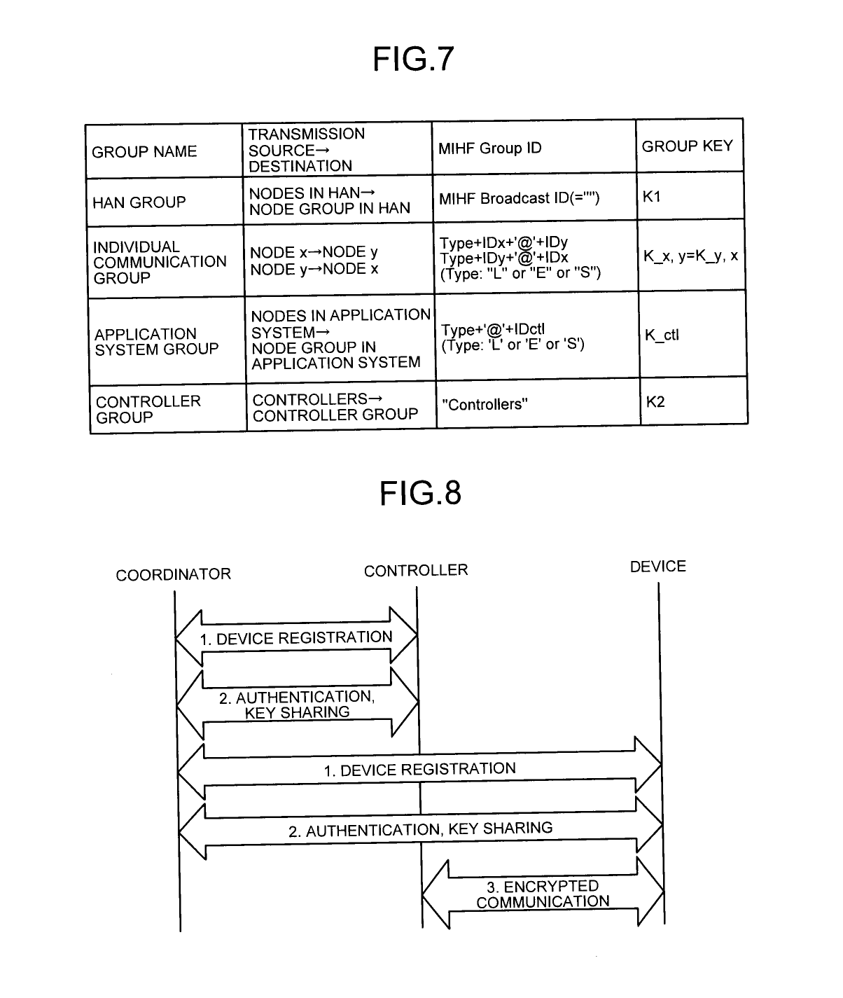

In group communication, an MIHF Group ID defined according to IEEE 802.21d is used as an IEEE 802.21 DestinationIdentifier assigned to a packet. The value of the MIHF Group ID differs from group to group. FIG. 7 is a table illustrating a group assignment rule according to the embodiment. For the HAN group, an MIHF Broadcast ID(=“ ”) is used as the MIHF Group ID. For an individual communication group, Type+IDx+‘@’+IDy is used as the MIHF Group ID. Examples of the MIHF Group IDs of individual communication groups include “L10@20”, “E00112233AABBCCDD@00112233BBCCDDEEFF”, and “S0011@AABB”.

For an application system group, Type+‘@’+IDctl is used as the MIHF Group ID. Examples of the MIHF Group IDs of application system groups include “L@20”, “E@00112233BBCCDDEEFF”, and “S@AABB”. For the controller group, “Controllers” is used as the MIHF Group ID. In the following, MIHF Group IDs other than the MIHF ID and the MIHF Broadcast may be expressed as “ID(Type)”. For example, an MIHF Group ID “L10@20” is expressed as 10@20(L).

Communication Procedures

FIG. 8 is an overall sequence illustrating an example of communication procedures according to the embodiment. As illustrated in FIG. 8, “1. device registration” and “2. authentication/key sharing” are carried out between the coordinator 20 and a controller 30, and “3. encrypted communication” is carried out between a controller 30 and a device 40. Similarly, “1. device registration” and “2. authentication/key sharing” are carried out between the coordinator 20 and a device 40, and “3. encrypted communication” is carried out between a controller 30 and a device 40. Note that, in “1. device registration” and “2. authentication/key sharing,” the controller 30 and the device 40 can be started in any order. In the following, the controller 30 and the device 40 may be referred to as “participating nodes.”

First, device registration is carried out between the participating nodes and the coordinator 20. The participating nodes find the coordinator 20 by using UPnP, ECHONET Lite (both without security), or the like. Upon receiving a broadcast over UPnP, ECHONET Lite, or the like, the coordinator 20 registers the transmission source. Note that the registration may be determined when authentication/key sharing, which will be described later, is successful. If the authentication/key sharing results in a failure, the registration is discarded.

Subsequently, authentication and key sharing are carried out between the participating nodes and the coordinator 20. In the authentication between the participating nodes and the coordinator 20, certificates are exchanged for mutual authentication. When the authentication is successful, the coordinator 20 encrypts an 802.21d device key to be used for the key sharing and distributes the encrypted device key to the participating nodes. In order to reduce the processing load at reboot, the participating nodes are assumed to retain information distributed from the coordinator 20 during the authentication and the key sharing in a nonvolatile memory.

The key sharing between the participating nodes and the coordinator 20 is carried out through distribution of a group key from the coordinator 20 to the participating nodes. The group key may be distributed without any request from the participating nodes (push) or may be distributed upon request from the participating nodes (pull). Furthermore, the coordinator 20 may distribute, to a participating node, a certificate on another participating node.

Thereafter, encrypted communication is carried out between the participating nodes. In addition to encrypted communication between a controller 30 and a device 40, encrypted communication may also be carried out between controllers 30 and between devices. A message to be used for encrypted communication contains an encrypted ECHONET Lite telegraphic message, and can have a digital signature added thereto by a transmission source node. In the present embodiment, when a multicast is used for message transmission, for example, an All Nodes link local address (FF02:0:0:0:0:0:0:1) is used as the multicast address if the range of the domain matches with the range of an IP link.

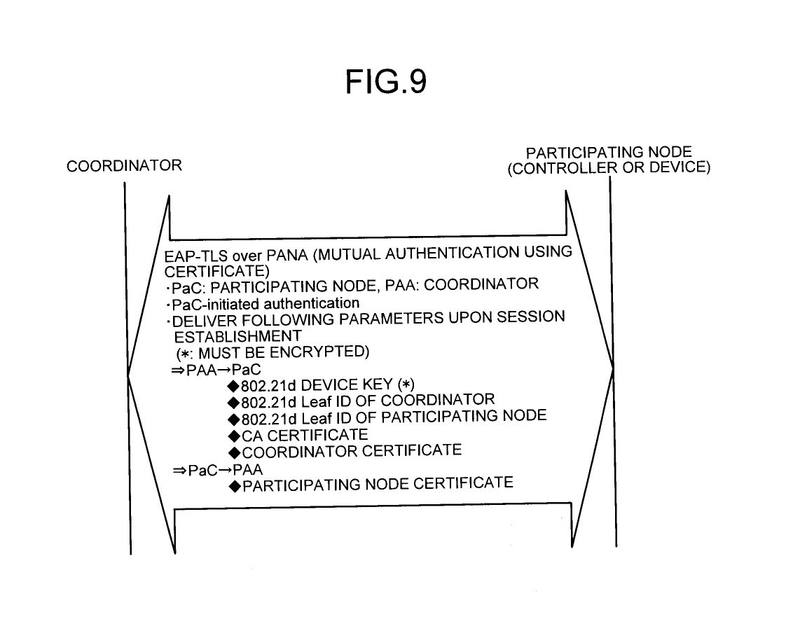

FIG. 9 is an example of an authentication sequence according to the embodiment. In the authentication, mutual authentication using EAP-TLS defined by RFC 5216 using a certificate in PANA is carried out. In this process, X.509 certificate exchange and Elliptic curve Diffie-Hellman (ECDH) key exchange are carried out, and mutual authentication and a session key are established. An X.509 certificate from a certificate authority (CA) may also be distributed from the coordinator 20 to the participating nodes. If the authentication is successful, at least the 802.21d device keys of the participating nodes, the 802.21d Leaf ID of the coordinator 20, and the 802.21d Leaf IDs of the participating nodes are distributed from the coordinator 20 to the participating nodes. The 802.21d device keys of the participating nodes need to be encrypted before distribution. For the encryption in this process, an encryption function defined by RFC 6786 is used. Note that an established PANA session may be immediately deleted.

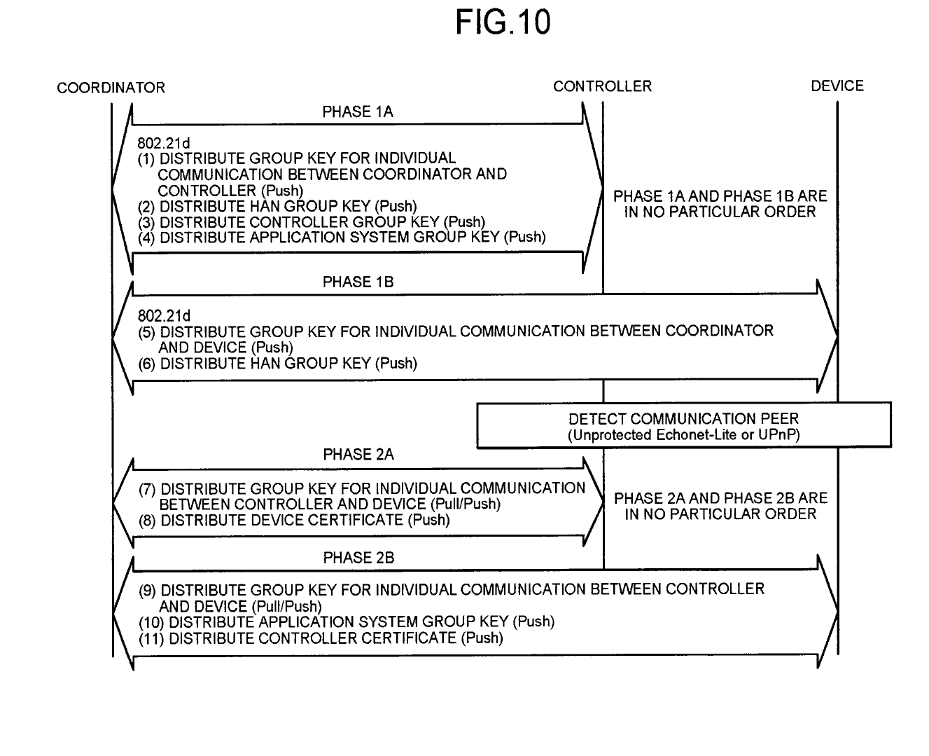

FIG. 10 is an example of a key sharing sequence according to the embodiment. The key sharing is divided into a phase (phase 1) carried out after completion of the authentication between the participating nodes and the coordinator 20 and a phase (phase 2) carried out when a participating node has found a communication peer with which to carry out encrypted communication. The phase 1 is divided into a phase 1A that is key sharing between the coordinator 20 and a controller 30 and a phase 1B that is key sharing between the coordinator 20 and a device 40. Note that either the phase 1A or the phase 1B may be carried out first. The phase 2 is divided into a phase 2A that is key sharing between the coordinator 20 and a controller 30 and a phase 2B that is key sharing between the coordinator 20 and a device 40. Note that either the phase 2A or the phase 2B may be carried out first. In each of the phase 1A, the phase 1B, the phase 2A, and the phase 2B, key sharing is carried out using IEEE 802.21d. The phases will be described below.

In the phase 1A, the coordinator 20 distributes a group key for individual communication between the coordinator 20 and the controller 30 to the controller 30 through pushing (see (1) in FIG. 10). The coordinator 20 then distributes a HAN group key to the controller 30 through pushing (see (2) in FIG. 10). Subsequently, the coordinator 20 distributes a controller group key to the controller 30 through pushing (see (3) in FIG. 10). Thereafter, the coordinator 20 distributes an application system group key to the controller 30 through pushing (see (4) in FIG. 10).

In the phase 1B, the coordinator 20 distributes a group key for individual communication between the coordinator 20 and the device 40 to the device 40 through pushing (see (5) in FIG. 10). The coordinator 20 then distributes the HAN group key to the device 40 through pushing (see (6) in FIG. 10).

In the phase 2A, the coordinator 20 distributes a group key for individual communication between the controller 30 and the device 40 to the controller 30 through pulling or pushing (see (7) in FIG. 10). Note that the distribution is carried out through pulling when the phase 2A is carried out prior to the phase 2B and that the distribution is carried out through pushing when the phase 2B is carried out prior to the phase 2A. The coordinator 20 then distributes an X.509 certificate of the device 40 to the controller 30 through pushing (see (8) in FIG. 10).

In the phase 2B, the coordinator 20 distributes a group key for individual communication between the controller 30 and the device 40 to the device 40 through pulling or pushing (see (9) in FIG. 10). Note that the distribution is carried out through pulling when the phase 2A is carried out prior to the phase 2B and that the distribution is carried out through pushing when the phase 2B is carried out prior to the phase 2A. The coordinator 20 then distributes the application system group key to the device 40 through pushing (see (10) in FIG. 10). Subsequently, the coordinator 20 distributes an X.509 certificate of the controller 30 to the device 40 through pushing (see (11) in FIG. 10).

In the key sharing sequence illustrated in FIG. 10, (3) is unnecessary when no controller group key is used. Furthermore, (4) and (10) are unnecessary when no application system group key is used. Furthermore, (8) is unnecessary when the transmission source signature of the device 40 is not added in the encrypted communication. Furthermore, group key distribution through pushing may be replaced by group key distribution through pulling.

In the steps other than (1) and (5), the IEEE 802.21d messages exchanged between the coordinator 20 and the participating nodes are transmitted to groups for individual communication between the coordinator 20 and the participating nodes. Furthermore, the IEEE 802.21d messages exchanged in (1) and (5) are transmitted to individual nodes. The steps (1) to (11) in FIG. 10 can be classified into three basic procedures of “group key distribution through pushing”, “group key distribution through pulling”, and “certificate distribution through pushing”. Hereinafter, the three procedures will be described.

In group key distribution through pushing, the coordinator 20 transmits an MIH_Net_Group_Manipulate request message to the participating nodes. A participating node in receipt of the MIH_Net_Group_Manipulate request message transmits an MIH_Net_Group_Manipulate response message to the coordinator 20.

In group key distribution through pulling, a participating node transmits an MIH_{—} MN_Group_Manipulate request message to the coordinator 20. The coordinator 20 in receipt of the MIH_MN_Group_Manipulate request message transmits an MIH_MN_Group_Manipulate response message to the participating node.

In certificate distribution through pushing, the coordinator 20 transmits an MIH_Push_Certificate request message to a participating node. The participating node in receipt of the MIH_Push_Certificate request message transmits an MIH_Push_Certificate response message to the coordinator 20.

Encrypted communication supports unicast encrypted communication and multicast encrypted communication. In unicast encrypted communication and multicast encrypted communication, MIH_Configuration_Update indication messages containing encrypted ECHONET Lite messages are used. The MIH_Configuration_Update indication message in the unicast encrypted communication is transmitted to an individual communication group. The MIH_Configuration_Update indication message in the multicast encrypted communication is transmitted to groups other than the individual communication groups.

In certificate revocation, the coordinator 20 transmits an MIH_Revoke_Certificate request message in multicast or unicast. When the MIH_Revoke_Certificate request message is transmitted in multicast, the node (the controller 30 or the device 40) in receipt of the MIH_Revoke_Certificate request message within the domain transmits an MIH_Revoke_Certificate response message in unicast to the coordinator 20.

The unicast MIH_Revoke_Certificate request message in certificate revocation is transmitted to the group for individual communication between the coordinator 20 and the participating node. The multicast MIH_Revoke_Certificate request message is transmitted to the HAN group. The MIH_Revoke_Certificate response message is transmitted to the group for individual communication between the coordinator 20 and the participating node. Certificate revocation in unicast can be carried out in combination with certificate revocation in multicast.

For key update, the coordinator 20 starts group key distribution through pushing. In this process, an MIH_Net_Group_Manipulate request message is broadcast in multicast or transmitted in unicast to individual nodes. A participating node (the controller 30 or the device 40) in receipt of the MIH_Net_Group_Manipulate request message transmits an MIH_Net_Group_Manipulate response message in unicast to the coordinator 20.

The unicast MIH_Net_Group_Manipulate request in key update message is transmitted to the group for individual communication between the coordinator 20 and the participating node. The multicast MIH_Net_Group_Manipulate request message is transmitted to the HAN group. The MIH_ Net_ Group_ Manipulate response message is transmitted to the group for individual communication between the coordinator 20 and the participating node. Key update in unicast can be carried out in combination with group key update in multicast.

Key update for a group is started when a member has left the group, when the group is deleted, or when re-registration is conducted by a member of the group. Furthermore, it is preferable to avoid instantaneous interruption of communication due to key update, and the following implementation is recommended in packet transmission and packet reception. In packet transmission, an old key is used for a certain period (T) after reception of a new key by the coordinator 20, and the new key is used after the period (T). In packet reception, both of a new key and an old key can be used for a certain period (2T) after reception of the new key by the coordinator 20. Note that “T” is a maximum value of key update time, and a default value thereof is 180 seconds, for example.

A participating node that does not have a new key as a result of a failure in receiving the new key during key update may start group key distribution through pulling upon receiving a message encrypted with the new key to a group to which the node belongs. If the coordinator 20 has received no MIH_Net_Group_Manipulate response message from any of the nodes belonging to the group for the certain period 2T as a result of key update, the key update results in a failure. The coordinator 20 that has failed in key update may retry the key update, whereby a new key may be generated at each retrial of key update.

For deleting a group, key update specifying an empty Complete Subtree is carried out on the group to be deleted. Alternatively, key update using a Complete Subtree containing only one unused leaf node in a group management tree is carried out.

Security

Among common security processes applied to all the message in IEEE 802.21d used in the present embodiment, part that are not defined in detail by IEEE 802.21d will be defined. Security for protecting IEEE 802.21d messages include two types: secrecy and transmission source authentication. Of these types, the secrecy is achieved by using AES-CCM. The transmission source authentication is achieved by using ECDSA with a key length of 256 bits. When the secrecy is valid, a security association identifier (SAID), a type length value (TLV), and a security TLV are used. When the transmission source authentication is valid, a signature TLV is used. When both of the secrecy and the transmission source authentication are valid, a SAID TLV, a security TLV, and a signature TLV are used. Hereinafter, security policies on protection of IEEE 802.21d messages and a method for updating sequence numbers used in AES-CCM will be described.

The security policies include security policies for individual communication and security policies for group communication. In the present embodiment, individual communication refers to one-to-one communication using an MIHF ID for DestinationIdentifier of IEEE 802.21d. Group communication refers to multipoint-to-multipoint communication using an MIHF Group ID for DestinationIdentifier of IEEE 802.21d. Communication where the number of group members is two, which is a special case of group communication, is referred to as individual group communication. Individual communication and individual group communication are distinguished from each other in terms of security policies.

For individual communication, the secrecy is always invalid and the transmission source authentication is always valid. For group communication, security policies such as an overall policy, a policy for each transmission source, a policy for each message, and the like are set for each group. The overall policy is a security policy applied to the entire subject group. For the overall policy, a policy of either “valid” or “invalid” is set. The policy for each transmission source is a security policy applied to each of transmission sources in the same group. For the policy for each transmission source, a transmission source to which an exception to the overall policy is applied is specified. For example, the policy for each transmission source is an exception=“invalid” when the overall policy is “valid”, and is an exception=“valid” when the overall policy is “invalid”. The policy for each transmission source is specified by a list of transmission source identifiers to which an exception to the overall policy is to be applied, a Bloom Filter, or a Complete Subtree.

The policy for each message is a policy applied to each of messages in the same group. For the policy for each message, a message to which an exception to the overall policy is applied is specified. For example, the policy for each message is an exception=“invalid” when the overall policy is “valid”, and is an exception=“valid” when the overall policy is “invalid”. The policy for each message is specified by a list of message identifiers to which an exception to the overall policy is to be applied, a Bloom Filter, or a bitmap.

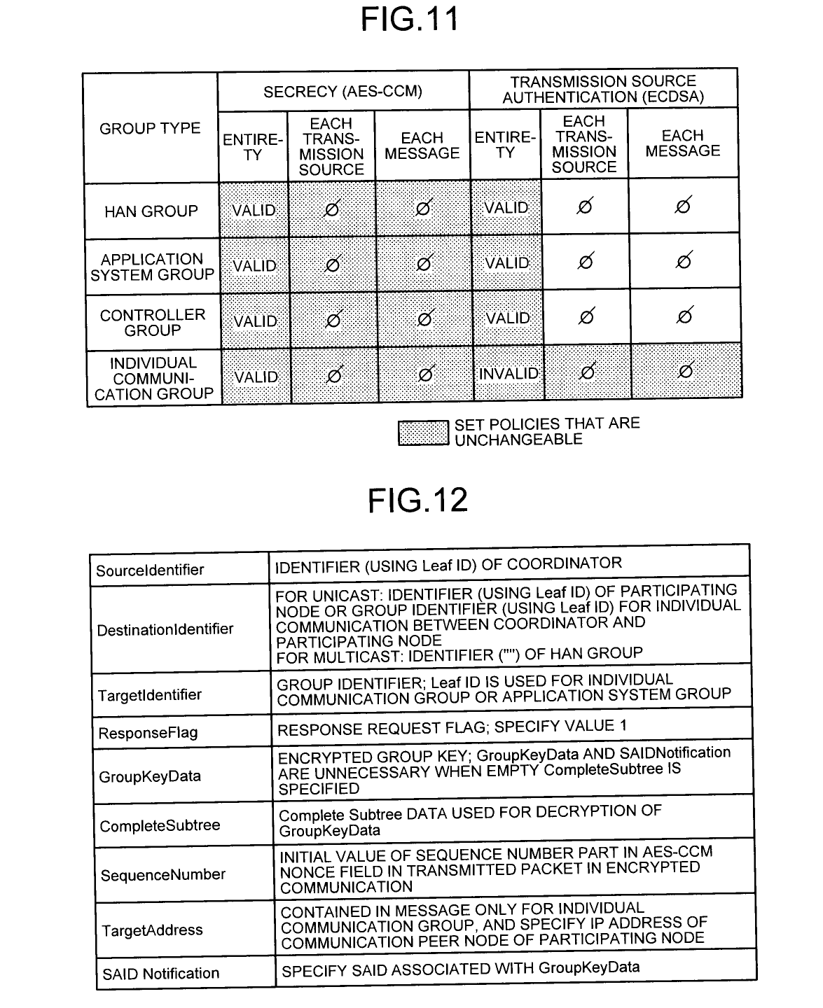

FIG. 11 is a table illustrating an example of default values of group communication security policies according to the embodiment. In FIG. 11, hatched entries cannot be changed. Security policies that can be changed by setting are policies for each transmission source and policies for each message relating to transmission source authentication other than that for individual communication group. A security policy that can be changed is set by any of setting in advance, embedding policy information in a group identifier, and notification using a group operation command. Note that the group operation command is MIH_ Group_{—} or MIH_Net_Group_Manipulate.

For AES-CCM of IEEE 802.21d, a 13-octet nonce is used. For the nonce is a connection of TransactionID (2 octets), SequenceNumber (10 octets), and FragmentNumber (1 octet). Among these, TransactionID and FragmentNumber other than SequenceNumber are fields of a packet header. In IEEE 802.21d, SequenceNumber is managed for each group. In authentication and key sharing, the nodes are notified of SequenceNumber=0. SequenceNumber is reset to 0 in key update and the nodes are notified of the reset SequenceNumber through key update procedures.

At reboot of a node, if the rebooted node does not retain the SequenceNumber used before the reboot, the rebooted node carries out re-registration with the coordinator 20 by MIH Re-registration (MIH registration with a request code=1). The coordinator 20 carries out key update for each group to which the re-registered node belongs. In this process, authentication and re-authentication using PANA are not necessary. In the present embodiment, since SequenceNumber is of 10 octets, it is assumed that not all of the values of SequenceNumber will be used while a group exits. Note that existence of a group refers to that one or more nodes are included in the group.

IEEE 802.21d Message TLV

Security-policy-independent TLVs contained in IEEE 802.21d messages used in the present embodiment will be described. The security-policy-independent TLVs are IEEE 802.21d TLVs other than SAID TLVs, Security TLVs, and Signature TLVs.

FIG. 12 is a table illustrating examples of the security-policy-independent TLVs contained in MIH_Net_Group_Manipulate request messages according to the embodiment. As illustrated in FIG. 12, SourceIdentifier is an identifier of the coordinator 20. For unicast, DestinationIdentifier is an identifier of a participating node or an identifier of a group for individual communication between the coordinator 20 and a participating node. For multicast, DestinationIdentifier is an identifier of the HAN group. TargetIdentifier is a group identifier and a Leaf ID is used for an individual communication group or an application system group.

ResponseFlag is a response request flag, and specifies a value “1”. GroupKeyData is an encrypted group key, and GroupKeyData and SAIDNotification are unnecessary when empty CompleteSubtree is specified. CompleteSubtree is CompleteSubtree data used for decryption of GroupKeyData. SequenceNumber is an initial value of a SequenceNumber part in an AES-CCM nonce field in a transmitted packet in encrypted communication. TargetAddress is contained in a message for an individual communication group, and specifies an IP address of a communication peer node of a participating node. SAID Notification specifies SAID associated with GroupKeyData.

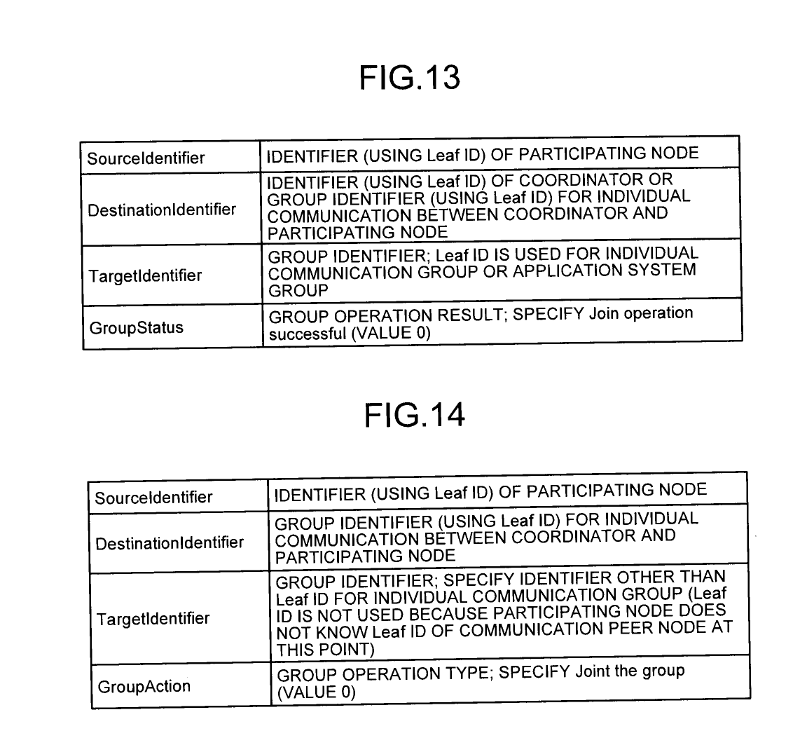

FIG. 13 is a table illustrating examples of the security-policy-independent TLVs contained in MIH_Net_Group_Manipulate response messages according to the embodiment. As illustrated in FIG. 13, SourceIdentifier is an identifier of a participating node. DestinationIdentifier is an identifier of the coordinator 20, or a group identifier for individual communication between the coordinator 20 and a participating node. TargetIdentifier is a group identifier and a Leaf ID is used for an individual communication group or an application system group. GroupStatus is a group operation result, and specifies Join operation successful (value “0”).

FIG. 14 is a table illustrating examples of the security-policy-independent TLVs contained in MIH_MN_Group_Manipulate request messages according to the embodiment. As illustrated in FIG. 14, SourceIdentifier is an identifier of a participating node. DestinationIdentifier is a group identifier for individual communication between the coordinator 20 and a participating node. TargetIdentifier is a group identifier, and specifies an identifier other than Leaf ID for an individual communication group. GroupAction is a group operation type, and specifies Join the group (value “0”).

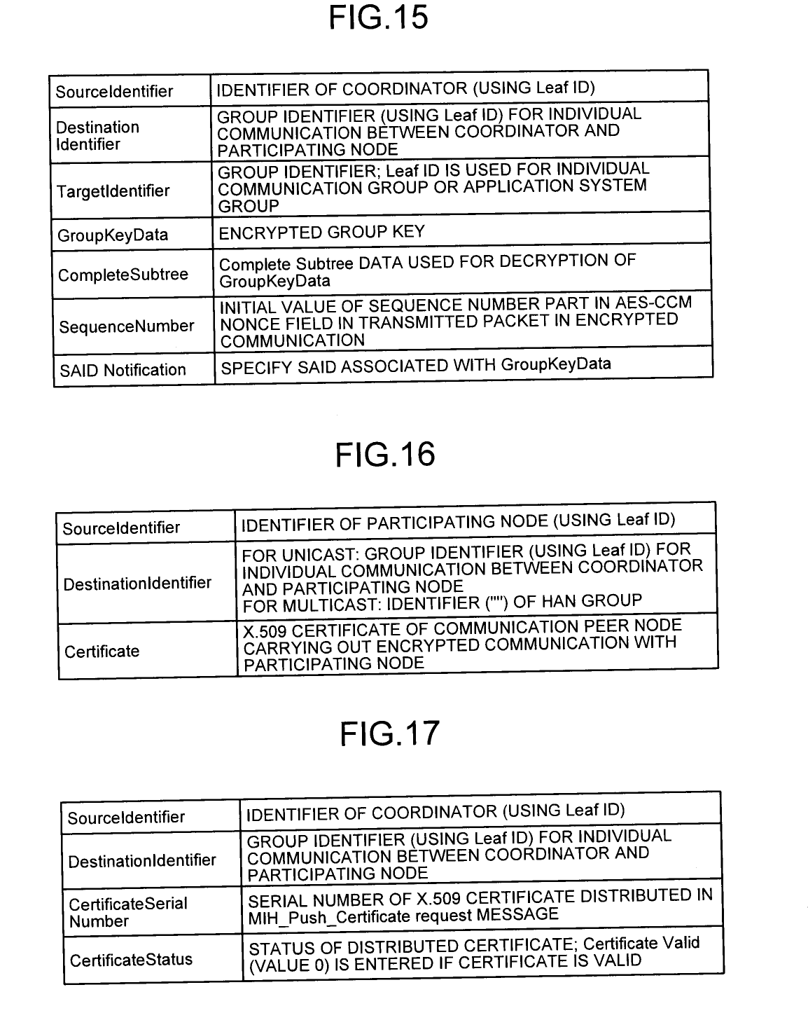

FIG. 15 is a table illustrating examples of the security-policy-independent TLVs contained in MIH_MN_Group_Manipulate response messages according to the embodiment. As illustrated in FIG. 15, SourceIdentifier is an identifier of the coordinator 20. DestinationIdentifier is a group identifier for individual communication between the coordinator 20 and a participating node. TargetIdentifier is a group identifier and a Leaf ID is used for an individual communication group or an application system group. GroupKeyData is an encrypted group key. CompleteSubtree is CompleteSubtree data used for decryption of GroupKeyData. SequenceNumber is an initial value of a SequenceNumber part in an AES-CCM nonce field in a transmitted packet in encrypted communication. SAID Notification specifies SAID associated with GroupKeyData.

FIG. 16 is a table illustrating examples of the security-policy-independent TLVs contained in MIH_Push_Certificate request messages according to the embodiment. As illustrated in FIG. 16, SourceIdentifier is an identifier of a participating node. For unicast, DestinationIdentifier is a group identifier for individual communication between the coordinator 20 and a participating node. For multicast, DestinationIdentifier is an identifier of the HAN group. Certificate is an X.509 certificate of a communication peer that carries out encrypted communication with a participating node.

FIG. 17 is a table illustrating examples of the security-policy-independent TLVs contained in MIH_ Push_ Certificate response messages according to the embodiment. As illustrated in FIG. 17, SourceIdentifier is an identifier of the coordinator 20. DestinationIdentifier is an identifier of a group for individual communication between the coordinator 20 and a participating node. CertificateSerialNumber is a serial number of an X.509 certificate distributed in an HIM_Push_Certificate request message. CertificateStatus is a status of a distributed certificate, and Certificate Valid (value “0”) is entered when the certificate is valid.

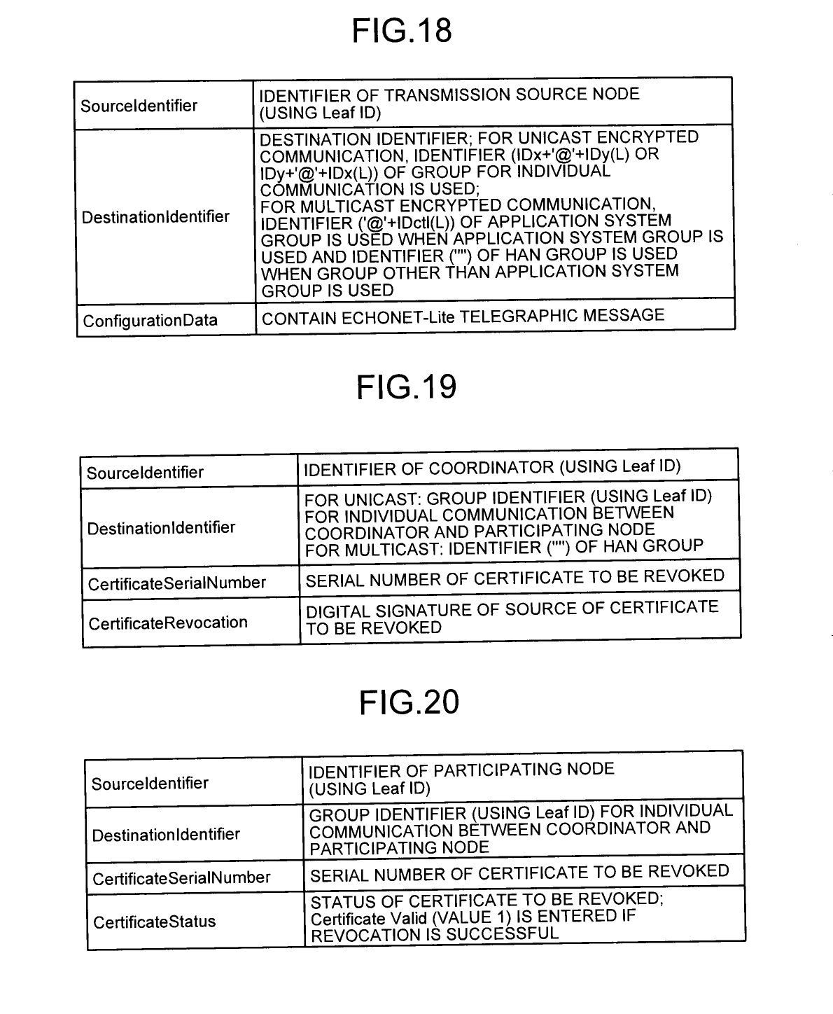

FIG. 18 is a table illustrating examples of the security-policy-independent TLVs contained in MIH_Configuration_Update indication messages according to the embodiment. As illustrated in FIG. 18, SourceIdentifier is an identifier of a transmission source node. DestinationIdentifier is a destination identifier, and an identifier of an individual communication group is used for unicast encrypted communication. Note that the identifier of an individual communication group is IDx+‘@’+IDy(L) or IDy+‘@’+IDx(L). For multicast encrypted communication, DestinationIdentifier is an identifier (‘@’+IDctl(L)) of an application system group when an application system group is used or an identifier (“ ”) of the HAN group when a group other than the application system group is used. ConfigurationData contains an ECHONET Lite telegraphic message.

FIG. 19 is a table illustrating examples of the security-policy-independent TLVs contained in MIH_Revoke_Certificate request messages according to the embodiment. As illustrated in FIG. 19, SourceIdentifier is an identifier of the coordinator 20. For unicast, DestinationIdentifier is a group identifier for individual communication between the coordinator 20 and a participating node. For multicast, DestinationIdentifier is an identifier of the HAN group. CertificateSerialNumber is a serial number of a certificate to be revoked. CertificateRevocation is digital signature of a source of a certificate to be revoked.

FIG. 20 is a table illustrating examples of the security-policy-independent TLVs contained in MIH_Revoke_Certificate response messages according to the embodiment. As illustrated in FIG. 20, SourceIdentifier is an identifier of a participating node. DestinationIdentifier is an identifier of a group for individual communication between the coordinator 20 and a participating node. CertificateSerialNumber is a serial number of a certificate to be revoked. CertificateStatus is a status of a certificate to be revoked, and Certificate Valid (value “1”) is set when the revocation is successful.

Next, detailed sequences of key sharing, encrypted communication, certificate revocation, and key update according to the present embodiment will be described.

Detailed Sequence of Key Sharing Phase 1

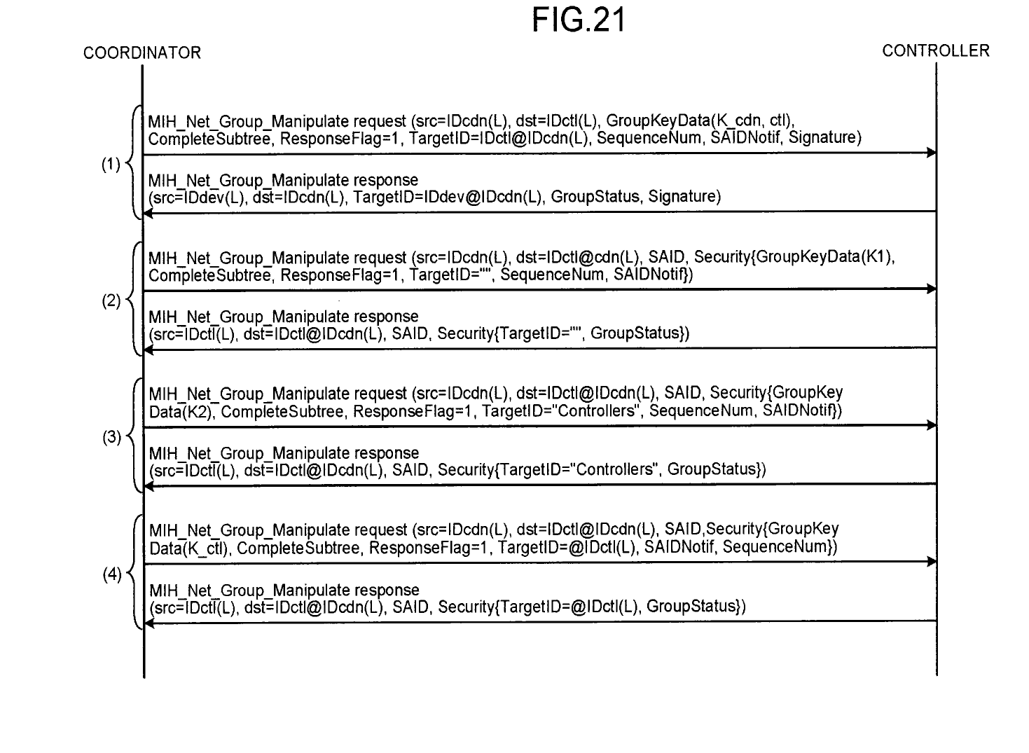

FIG. 21 is an example of a detailed sequence of the key sharing phase 1A according to the embodiment. In FIG. 21, IDctl represents an identifier of a controller 30, IDcdn represents an identifier of the coordinator 20, and IDdev represents an identifier of a device 40. In addition, (1) to (4) in FIG. 21 correspond to (1) to (4) in FIG. 10.

As in (1) of FIG. 21, the coordinator 20 transmits an MIH_Net_Group_Manipulate request message to a controller 30. The MIH_Net_Group_Manipulate request message contains “src=IDcdn(L), dst=IDctl(L), GroupKeyData(K_cdn,ctl), CompleteSubtree, ResponseFlag=1, TargetID=IDctl@IDcdn(L), SequenceNum, SAIDNotif, Signature”. The controller 30 in receipt of the MIH_ Net_Group_Manipulate request message transmits an MIH_Net_Group_Manipulate response message to the coordinator 20. The MIH_Net_Group_Manipulate response message contains “src=IDdev(L), dst=IDcdn(L), TargetID=IDdev@IDcdn(L), GroupStatus, Signature”.

As in (2) of FIG. 21, the coordinator 20 transmits an MIH_Net_ Group_Manipulate request message to the controller 30. The MIH_ Net_ Group_Manipulate request message contains “src=IDcdn(L), dst=IDctl@IDcdn(L), SAID, Security{GroupKeyData(K1), CompleteSubtree, ResponseFlag=1, TargetID=“ ”, SequenceNum, SAIDNotif}”. The controller 30 in receipt of the MIH_Net_Group_Manipulate request message transmits an MIH_Net_Group_Manipulate response message. The MIH_Net_Group_Manipulate response message contains “src=IDctl(L), dst=IDctl@IDcdn(L), SAID, Security{TargetID=“ ”, GroupStatus}”.

As in (3) of FIG. 21, the coordinator 20 transmits an MIH_Net_Group_Manipulate request message to the controller 30. The MIH_Net_Group_Manipulate request message contains “src=IDcdn(L), dst=IDctl@IDcdn(L), SAID, Security{GroupKeyData(K2), CompleteSubtree, ResponseFlag=1, TargetID=“Controllers”, SequenceNum, SAIDNotif}”. The controller 30 in receipt of the MIH_Net_Group_Manipulate request message transmits an MIH_Net_Group_{—} Manipulate response message to the coordinator 20. The MIH_Net_Group_Manipulate response message contains “src=IDctl(L), dst=IDctl@IDcdn(L), SAID, Security{TargetID=“Controllers”, GroupStatus}”.

As in (4) of FIG. 21, the coordinator 20 transmits an MIH_Net_Group_Manipulate request message to the controller 30. The MIH_Net_Group_Manipulate request message contains “src=IDcdn(L), dst=IDctl@IDcdn(L), SAID, Security{GroupKeyData(K_ctl), CompleteSubtree, ResponseFlag=1, TargetID=@IDctl(L), SAIDNotif, SequenceNum}”. The controller 30 in receipt of the MIH_Net_Group_Manipulate request message transmits an MIH_Net_Group_Manipulate response message to the coordinator 20. The MIH_Net_Group_Manipulate response message contains “src=IDctl(L), dst=IDctl@IDcdn(L), SAID, Security{TargetID=@IDctl(L), GroupStatus}”.

Note that, in the key sharing phase 1A, MIH registration defined in IEEE 802.21-2008 may be carried out to the coordinator 20 by the controller 30 prior to (1) in FIG. 21.

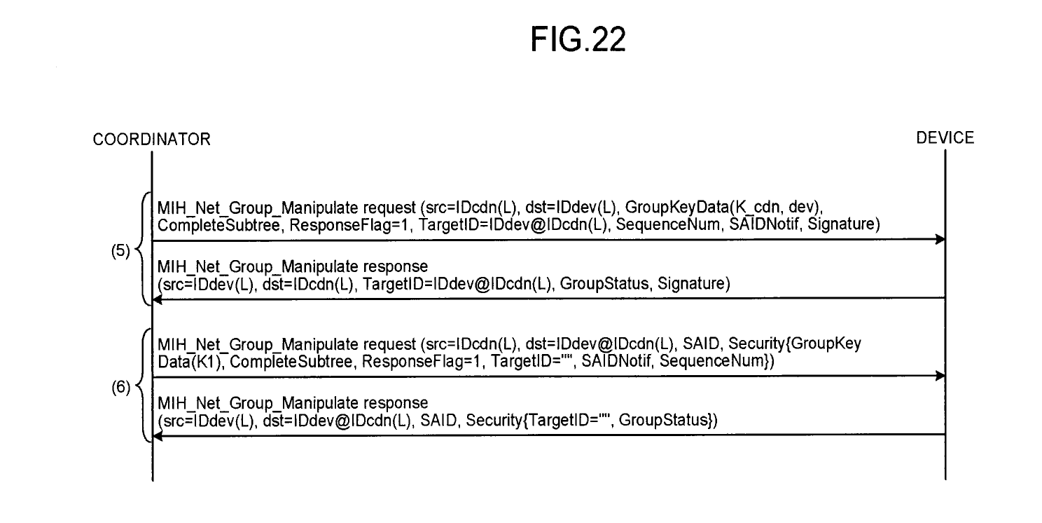

FIG. 22 is an example of a detailed sequence of the key sharing phase 1B according to the embodiment. In FIG. 22, IDctl represents the identifier of the controller 30, IDcdn represents the identifier of the coordinator 20, and IDdev represents the identifier of the device 40. In addition, (5) and (6) in FIG. 22 correspond to (5) and (6) in FIG. 10.

As in (5) of FIG. 22, the coordinator 20 transmits an MIH_ Net_ Group_Manipulate request message to the device 40. The MIH_Net_Group_Manipulate request message contains “src=IDcdn(L), dst=IDdev(L), GroupKeyData(Kcdn,dev), CompleteSubtree, ResponseFlag=1, TargetID=IDdev@IDcdn(L), SequenceNum, SAIDNotif, Signature”. The device 40 in receipt of the MIH_Net_Group_Manipulate request message transmits an MIH_Net_Group_Manipulate response message to the coordinator 20. The MIH_Net_Group_Manipulate response message contains “src=IDdev(L), dst=IDcdn(L), TargetID=IDdev@IDcdn(L), GroupStatus, Signature”.

As in (6) of FIG. 22, the coordinator 20 transmits an MIH_Net_Group_Manipulate request message to the device 40. The MIH_Net_Group_Manipulate request message contains “src=IDcdn(L), dst=IDdev@IDcdn(L), SAID, Security{GroupKeyData(K1), CompleteSubtree, ResponseFlag=1, TargetID=“ ”, SAIDNotif, SequenceNum}”. The device 40 in receipt of the MIH_{—} Net_{—} Group_{—} Manipulate request message transmits an MIH_Net_Group_Manipulate response message to the coordinator 20. The MIH_Net_Group_Manipulate response message contains “src=IDdev(L), dst=IDdev@IDcdn(L), SAID, Security{TargetID=“ ”, GroupStatus}”.

Note that, in the key sharing phase 1B, MIH registration defined in IEEE 802.21-2008 may be carried out to the coordinator 20 by the device 40 prior to (5) in FIG. 22.

Detailed Sequence of Key Sharing Phase 2

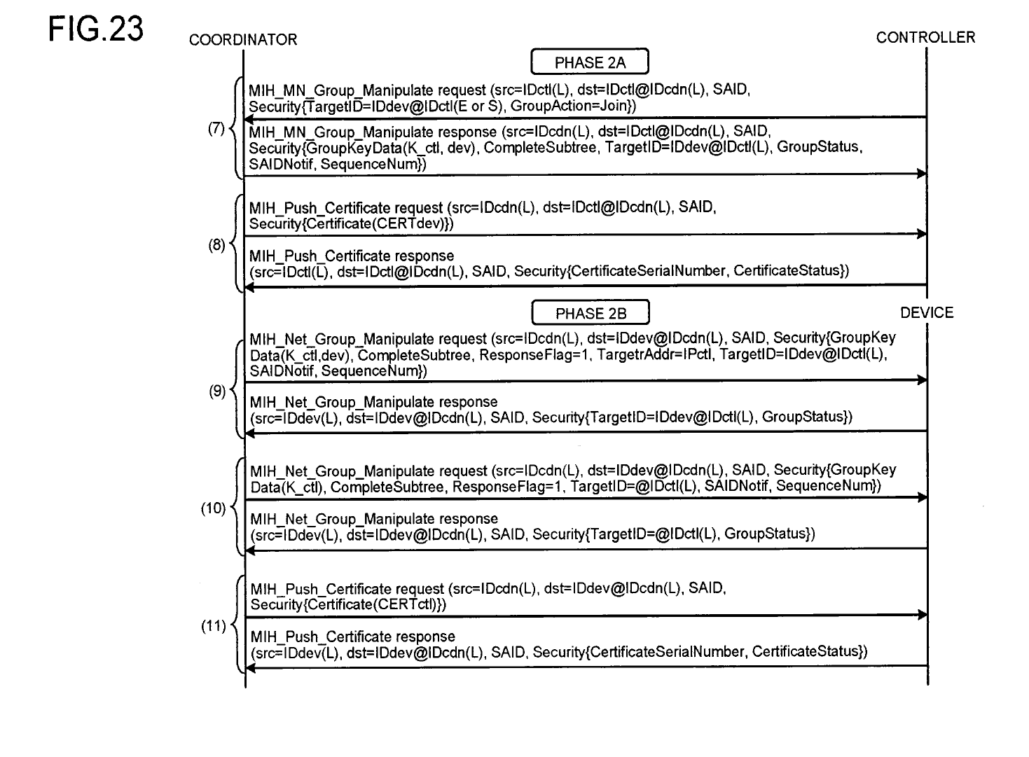

FIG. 23 is an example of a detailed sequence of the key sharing phase 2 according to the embodiment. FIG. 23 illustrates an example in which the phase 2A is carried out prior to the phase 2B. In FIG. 23, IDctl represents the identifier of the controller 30, IDcdn represents the identifier of the coordinator 20, and IDdev represents the identifier of the device 40. In addition, (7) to (11) in FIG. 23 correspond to (7) to (11) in FIG. 10.

As in (7) of FIG. 23, the controller 30 transmits an MIH_MN_Group_Manipulate request message to the coordinator 20. The MIH_ MN_ Group_Manipulate request message contains “src=IDctl(L), dst=IDctl@IDcdn(L), SAID, Security{TargetID=IDdev@IDctl(E or S), GroupAction=join}”. The coordinator 20 in receipt of the MIH_MN_Group_Manipulate request message transmits an MIH_MN_Group_Manipulate response message to the controller 30. The MIH_MN_Group_Manipulate response message contains “src=IDcdn(L), dst=IDctl@IDcdn(L), SAID, Security{GroupKeyData(K_ctl,dev), CompleteSubtree, TargetID=IDdev@IDctl(L), GroupStatus, SAIDNotif, SequenceNum}”.

As in (8) of FIG. 23, the coordinator 20 transmits an MIH_Push_Certificate request message to the controller 30. The MIH_Push_Certificate request message contains “src=IDcdn(L), dst=IDctl@IDcdn(L), SAID, Security{Certificate(CERTdev)}”. The controller 30 in receipt of the MIH_Push_Certificate request message transmits an MIH_Push_Certificate response message to the coordinator 20. The MIH_Push_Certificate response message contains “src=IDctl(L), dst=IDctl@IDcdn(L), SAID, Security{CertificateSerialNumber, CertificateStatus}”.

As in (9) of FIG. 23, the coordinator 20 transmits an MIH_Net_Group_Manipulate request message to the device 40. The MIH_Net_Group_Manipulate request message contains “src=IDcdn(L), dst=IDdev@IDcdn(L), SAID, Security{GroupKeyData(K_ctl,dev), CompleteSubtree, ResponseFlag=1, TargetAddr=IPctl, TargetID=IDdev@IDctl(L), SAIDNotif, SequenceNum}”. The device 40 in receipt of the MIH_Net_Group_Manipulate request message transmits an MIH_ Net_Group_Manipulate response message to the coordinator 20. The MIH_Net_Group_Manipulate response message contains “src=IDdev(L), dst=IDdev@IDcdn(L), SAID, Security{TargetID=IDdev@IDctl(L), GroupStatus}”.

As in (10) of FIG. 23, the coordinator 20 transmits an MIH_Net_Group_Manipulate request message to the device 40. The MIH_Net_Group_Manipulate request message contains “src=IDcdn(L), dst=IDdev@IDcdn(L), SAID, Security{GroupKeyData(Kctl), CompleteSubtree, ResponseFlag=1, TargetID=@IDctl(L), SAIDNotif, SequenceNum}”. The device 40 in receipt of the MIH_Net_Group_Manipulate request message transmits an MIH_Net_Group_Manipulate response message to the coordinator 20. The MIH_Net_Group_Manipulate response message contains “src=IDdev(L), dst=IDdev@IDcdn(L), SAID, Security{TargetID=@IDctl(L), GroupStatus}”.

As in (11) of FIG. 23, the coordinator 20 transmits an MIH_Push_Certificate request message to the device 40. The MIH_Push_Certificate request message contains “src=IDcdn(L), dst=IDdev@IDcdn(L), SAID, Security{Certificate(CERTctl)}”. The device 40 in receipt of the MIH_Push_Certificate request message transmits an MIH_{—} Push_{—} Certificate response message to the coordinator 20. The MIH_Push_Certificate response message contains “src=IDdev(L), dst=IDdev@IDcdn(L), SAID, Security{CertificateSeriaiNumber, CertificateStatus}”.

Note that, when the key sharing phase 2B is used for key sharing for communication between controllers 30, the device 40 (IDdev) in the key sharing phase 2B is replaced by a controller 30 (IDctl′) with which the controller 30 (IDctl) in the key sharing phase 2A communicates and (7) is not carried out. Alternatively, when the key sharing phase 2A is used for key sharing for communication between devices, the controller 30 (IDctl) in the key sharing phase 2A is replaced by a device 40 (IDdev′) with which the device 40 (IDdev) in the key sharing phase 2B communicates and (7) is not carried out.

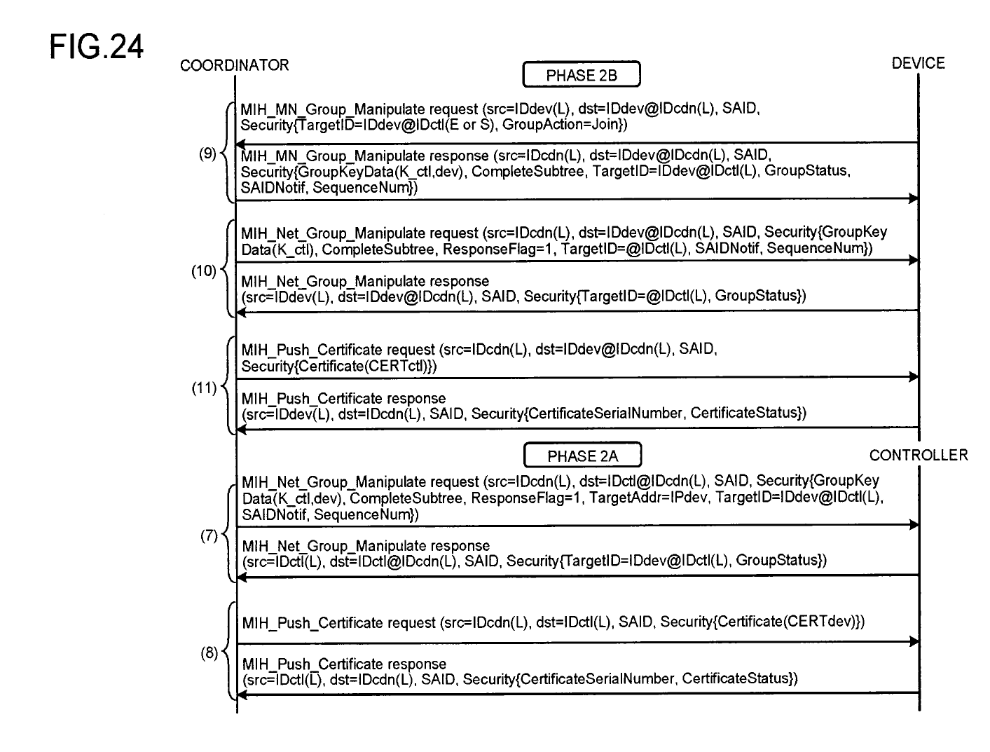

FIG. 24 is an example of a detailed sequence of the key sharing phase 2 according to the embodiment. FIG. 24 illustrates an example in which the phase 2B is carried out prior to the phase 2A. In FIG. 24, IDctl represents the identifier of the controller 30, IDcdn represents the identifier of the coordinator 20, and IDdev represents the identifier of the device 40. In addition, (7) to (11) in FIG. 24 correspond to (7) to (11) in FIG. 10.

As in (9) of FIG. 24, the device 40 transmits an MIH_MN_Group_Manipulate request message to the coordinator 20. The MIH_MN_Group_Manipulate request message contains “src=IDdev(L), dst=IDdev@IDcdn(L), SAID, Security{TargetID=IDdev@IDctl (E or S), GroupAction=join}”. The coordinator 20 in receipt of the MIH_MN_Group_Manipulate request message transmits an MIH_MN_Group_Manipulate response message to the device 40. The MIHMNGroupManipulate response message contains “src=IDcdn(L), dst=IDdev@IDcdn(L), SAID, Security{GroupKeyData(K_ctl,dev), CompleteSubtree, TargetID=IDdev@IDctl(L), GroupStatus, SAIDNotif, SequenceNum}”.

As in (10) of FIG. 24, the coordinator 20 transmits an MIH_Net_Group_Manipulate request message to the device 40. The MIH_Net_Group_Manipulate request message contains “src=IDcdn(L), dst=IDdev@IDcdn(L), SAID, Security{GroupKeyData(Kctl), CompleteSubtree, ResponseFlag=1, TargetID=@IDctl(L), SAIDNotif, SequenceNum}”. The device 40 in receipt of the MIH_Net_Group_Manipulate request message transmits an MIH_Net_Group_Manipulate response message to the coordinator 20. The MIH_Net_Group_Manipulate response message contains “src=IDdev(L), dst=IDdev@IDcdn(L), SAID, Security{TargetID=@IDctl(L), GroupStatus}”.

As in (11) of FIG. 24, the coordinator 20 transmits an MIH_Push_Certificate request message to the device 40. The MIH_ Push_ Certificate request message contains “src=IDcdn(L), dst=IDdev@IDcdn(L), SAID, Security{Certificate(CERTctl)}”. The device 40 in receipt of the MIH_Push_Certificate request message transmits an MIH_Push_Certificate response message to the coordinator 20. The MIH_Push_Certificate response message contains “src=IDdev(L), dst=IDcdn(L), SAID, Security{CertificateSerialNumber, CertificateStatus}”.

As in (7) of FIG. 24, the coordinator 20 transmits an MIH_Net_Group_Manipulate request message to the controller 30. The MIH_Net_Group_Manipulate request message contains “src=IDcdn(L), dst=IDctl@IDcdn(L), SAID, Security{GroupKeyData(K_ctl,dev), CompleteSubtree, ResponseFlag=1, TargetAddr=IPdev, TargetID=IDdev@IDctl(L), SAIDNotif, SequenceNum}”. The controller 30 in receipt of the MIH_Net_Group_Manipulate request message transmits an MIH_Net_Group_Manipulate response message to the coordinator 20. The MIH_Net_Group_Manipulate response message contains “src=IDctl(L), dst=IDctl@cdn(L), SAID, Security{TargetID=IDdev@IDctl(L), GroupStatus}”.

As in (8) of FIG. 24, the coordinator 20 transmits an MIH_Push_Certificate request message to the controller 30. The MIH_Push_Certificate request message contains “src=IDcdn(L), dst=IDctl(L), SAID, Security{Certificate(CERTdev)}”. The controller 30 in receipt of the MIH_Push Certificate request message transmits an MIH_Push_Certificate response message to the coordinator 20. The MIH_Push_Certificate response message contains “src=IDclt(L), dst=IDcdn(L), SAID, Security{CertificateSerialNumber, CertificateStatus}”.

Detailed Sequence of Encrypted Communication

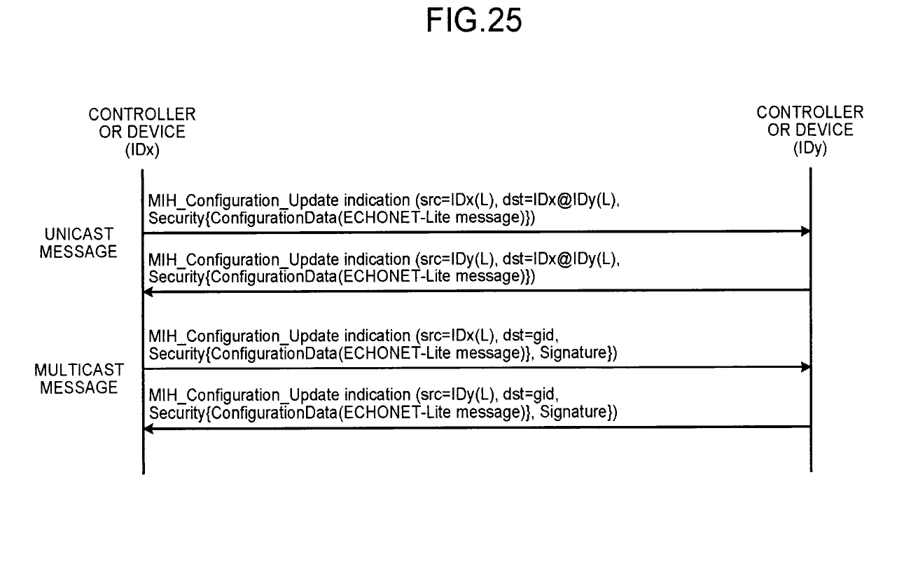

FIG. 25 is an example of a detailed sequence of encrypted communication according to the embodiment. As illustrated in FIG. 25, a controller 30 or a device 40 transmits or receives an MIH_Configuration_Update indication message to/from a controller 30 or a device 40 both through unicast encrypted communication and multicast encrypted communication. The transmission and reception of the MIH_Configuration_Update indication message are carried out by a controller 30 or a device 40 (IDx) and a controller 30 or a device 40 (IDy).

Detailed Sequence of Certificate Revocation

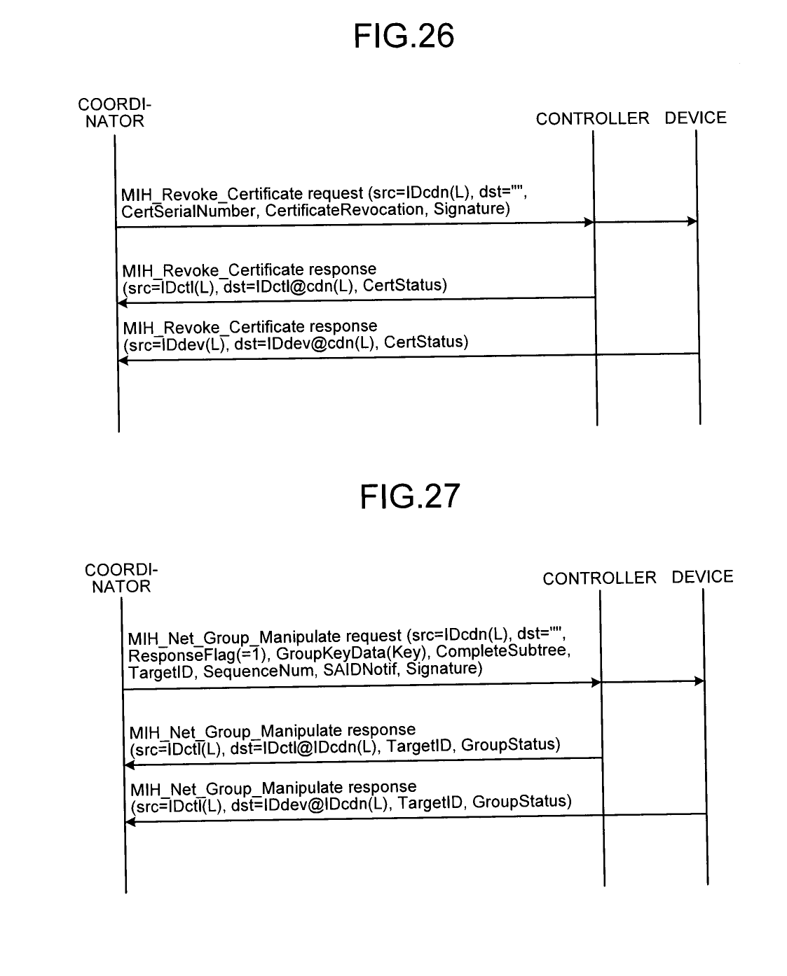

FIG. 26 is an example of a detailed sequence of certificate revocation according to the embodiment. As illustrated in FIG. 26, the coordinator 20 transmits an MIH_Revoke_Certificate request message in multicast or in unicast to a controller 30 or a device 40. As a result, the controller 30 or the device 40 transmits an MIH_Revoke_Certificate response message to the coordinator 20.

Detailed Sequence of Group Key Update

FIG. 27 is an example of a detailed sequence of group key update according to the embodiment. As illustrated in FIG. 27, the coordinator 20 transmits an MIH_Net_Group_Manipulate request message in multicast or in unicast to a controller 30 or a device 40. As a result, the controller 30 or the device 40 transmits an MIH_Net_Group_Manipulate response message to the coordinator 20.

According to the embodiment, since semantics of a group is expressed in the structure of a group identifier and a packet containing a variable value field in which the value is unchanged while the group exits is transmitted and received in the group, it is possible to improve the flexibility of the semantics and to simplify the communication.

Furthermore, processing procedures, control procedures, specific names, information including various data and parameters, etc., presented in the description or in the drawings may be changed in any manner unless otherwise stated. Furthermore, components of illustrated control devices are represent conceptual functions, and the devices need not necessarily be physically configured as illustrated. Thus, specific forms of distribution or incorporation of devices are not limited to those illustrated but the whole or part thereof can be functionally or physically distributed or incorporated in any units depending on various loads, usage conditions, etc.

Furthermore, the coordinator 20, the controllers 30, and the devices 40 included in the communication system 10 according to the present embodiment can be implemented by using a general-purpose computer system as basic hardware, for example. Programs to be executed have modular configuration including the functions described above. The programs may be recorded on a computer-readable recording medium such as a CD-ROM, a CD-R, or a DVD, in the form of files that can be installed or executed and provided therefrom, or may be embedded in a ROM or the like and provided therefrom.

While certain embodiments have been described, these embodiments have been presented by way of example only, and are not intended to limit the scope of the inventions. Indeed, the novel embodiment described herein may be embodied in a variety of other forms; furthermore, various omissions, substitutions and changes in the form of the embodiment described herein may be made without departing from the spirit of the inventions. The accompanying claims and their equivalents are intended to cover such forms or modifications as would fall within the scope and spirit of the inventions.

What is claimed is:

1. A communication system connected to a plurality of communication devices, the system comprising:
a controller configured to control, by using a group identifier representing semantics of a group including at least one of the communication devices, the at least one of the communication devices that has been authenticated when the group is operated, an index being assigned to the at least one of the communication devices.

2. The system according to claim 1, wherein the controller uses the group identifier containing a field of a variable value that is unchanged while the group to be operated exits, to control the at least one of the communication devices.

3. The system according to claim 1, wherein the controller uses, when a plurality of groups are present, the group identifier that is different for each of the groups, to control the at least one of the communication devices.

4. The system according to claim 2, wherein the controller uses the group identifier containing the field of the variable value containing an identifier of a representative communication device of the communication devices present in the group, to control the at least one of the communication devices.

5. The system according to claim 1, wherein the controller encrypts a packet containing the group identifier by using a group common key that is different for each group.

6. The system according to claim 5, wherein the control unit distributes the group common key by using IEEE 802.21d.

7. The system according to claim 1, wherein the group includes an individual communication group made up of two communication devices.

8. The system according to claim 4, wherein the identifier of the representative communication device is an identifier being the index, and an identifier of a leaf node of a group management tree corresponding to the representative communication device is used therefor.

9. The system according to claim 8, wherein in response to a request from one communication device in the individual communication group, the controller notifies the one communication device of an identifier of a leaf node of the group management tree corresponding to another communication device of the individual communication group.

10. The system according to claim 8, wherein the controller distributes an identifier and a device key of a leaf node corresponding to a communication device at initial connection of the communication device.

11. The system according to claim 1, wherein the control unit uses the group identifier containing information representing a security policy, to control the at least one of the communication devices.
